(19) United States
(12) Patent Application Publication
(10) Pub. No.: US 2021/0102334 A1
(43) Pub. Date: Apr. 8, 2021

(54) USE OF CARBOXYMETHYL STARCH IN GEOSYNTHETIC CLAY LINERS

(71) Applicant: Halliburton Energy Services, Inc., Houston, TX (US)

(72) Inventors: Thomas Scott Cortner, Willis, TX (US); Eric Frantz, Houston, TX (US)

(21) Appl. No.: 16/592,473

(22) Filed: Oct. 3, 2019

(51) Int. Cl. D06M 11/77; C08K 3/34; D06M 15/11

(52) U.S. Cl. CPC D06M 11/77; D06M 2200/10; D06M 15/11; C08K 3/346

(57) ABSTRACT

The present invention relates to improved bentonite barrier compositions, and more particularly, to the use of geosynthetic clay liners including these improved bentonite barrier compositions having enhanced low permeability over time in containment applications. A geosynthetic clay liner comprises at least one geosynthetic layer; and a bentonite barrier composition comprising bentonite and a polyanionic starch, wherein the polyanionic starch is carboxymethyl starch.

### TECHNICAL FIELD

The present disclosure relates generally to improved bentonite barrier compositions and, more particularly, to the use of geosynthetic clay liners including these improved bentonite barrier compositions having enhanced low permeability over time in containment applications.

### BACKGROUND

Various materials and procedures have been developed and utilized to form low permeability barriers in containment applications. For example, low permeability barriers are needed to separate waste fluids from contaminating the surrounding environment in fly-ash repositories, industrial mineral and metal mining sites, and landfill sites. These barriers are also useful for aqueous containment applications such as leachate ponds, retention ponds, and water storage reservoirs. The term “containment” when used herein refers to both aqueous containments (for example, ponds) as well as other containments that have components that are better separated from the surrounding environment (for example, fly-ash repositories). For example, “containment” may refer to the separation of ponds of liquid waste streams from industrial processes or leachates produced from these or other industrial processes from the surrounding environments. A “leachate” as that term is used herein refers to an effluent containing contaminants, produced from water (for example, rain/storm water) percolating through a depository (for example, a landfill, a fly-ash repository, etc.). A leachate usually contains a high concentration of electrolytes as compared to fresh water.

Clay materials, such as bentonite, have been used as low permeability barriers in containment applications. Bentonite is an aluminum phyllosilicate whose composition can vary in its dominant elements. When first mined or extracted, sodium bentonite often has a moisture content that is approximately about 30% to about 35% by weight. In many instances, this moisture may be removed to be about 6% to about 15% by weight. This is considered by the industry to be “dry” bentonite despite the significant moisture content. The moisture content may vary from application to application and may be dependent on exposure to fluids in the ground that hydrates the bentonite to a higher moisture content.

Bentonite barrier compositions are often formulated from natural or sodium exchanged bentonite and mixed with common fluid additives. The granularity or the relative particle size distribution, often described in terms of mesh size in the art, can determine how well the bentonite is packed and its ease of handling. A common use of bentonite geosynthetic clay liners is to line the base of landfills to prevent the migration of leachate and/or solutions containing high concentrations of electrolytes.

While bentonite is highly absorbent, able to absorb water several times its dry mass, aqueous fluids having complex chemistries can adversely affect its absorbency. These complex chemistries often involve electrolytes that may include, but are not limited to, cations and anions such as calcium, magnesium, potassium, iron, zirconium, lead, cobalt, copper, tin, silver, carbonates, sulfates, chlorides, fluorides, bromides, and the like. The composition of the electrolytes may vary based on the source material of the containment (for example, coal source for a fly-ash repository).

Bentonite can be used in conjunction with a geosynthetic layer to form a geosynthetic clay liner. This technique may allow for convenient transport and installation of the bentonite, and greatly reduces the amount of bentonite required. The primary indicator of the effectiveness of a liner is “permeability.” As used herein, the term “permeability” refers to the rate of flow of a fluid through a porous media (for example, a clay liner) as measured in terms of cm/s. These barrier compositions should meet the permeability specification set by regulations (for example, local, international, state and federal standards, etc.). It is desirable for a liner to be less permeable (i.e., have lower permeability) so that less materials are transported through the liner to the surrounding environment.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a geosynthetic clay liner, in accordance with an embodiment of the present disclosure

FIG. 2 illustrates a graphical comparison between the disclosed composition and conventional compositions, in accordance with an embodiment of the present disclosure; and

FIG. 3 illustrates a graphical comparison between the disclosed composition and conventional compositions, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business-related constraints, which will vary from one implementation to another. Moreover, it will be appreciated that such a development effort might be complex and time consuming but would nevertheless be a routine undertaking for those of ordinary skill in the art having the benefit of the present disclosure. Furthermore, in no way should the following examples be read to limit, or define, the scope of the disclosure.

The terms “couple” or “couples” as used herein are intended to mean either an indirect or a direct connection. Thus, if a first device couples to a second device, that connection may be through a direct connection, or through an indirect mechanical, electromagnetic, or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections. Finally, the term “fluidically coupled” as used herein is intended to mean that there is either a direct or an indirect fluid flow path between two components.

The present invention relates to improved bentonite barrier compositions, and more particularly, to the use of geosynthetic clay liners including these improved bentonite barrier compositions having enhanced low permeability over time in containment applications.

Of the many advantages of the present invention, the bentonite barrier compositions and geosynthetic clay liners of the present invention present long-lasting protection against contaminant seepage to the surrounding environment in containment applications involving complex chemistries. Containment applications often have complex electrolyte chemistries, which include electrolytes, such as anions and cations like calcium, potassium, magnesium, iron, zirconium, lead, cobalt, copper, tin, silver, sulfates, chlorides, bromides, fluorides, and any combination thereof. It is believed that the bentonite barrier compositions of the present invention are particularly useful in situations involving complex electrolyte chemistries because they contain a polyanionic polymer that is believed to bind (for example, chelate) the electrolytes in the containment. This binding is believed to prevent the electrolytes from interacting with the bentonite in an undesirable manner. Moreover, when used in geosynthetic clay liners, the bentonite barrier compositions of the present invention provide enhanced retained permeabilities throughout the period of use of the liner, which is advantageous in terms of retarding the rate of seepage out of the containment to the surrounding environment over time. The term “retained permeability” refers to the permeability of a barrier or liner after at least 8 days of exposure to a solution including at least 450 ppm of electrolytes (for example, calcium, magnesium, chloride, and sulfate). These advantages may be particularly important in view of rigorous regulations relating to containment applications.

The bentonite barrier compositions of the present invention generally include bentonite and a polyanionic starch. Optionally, other additives may be included, depending on the desirability of including any such additives. These compositions may be used alone, for example in amended soil applications, in geosynthetic clay liner applications, and combinations thereof. The term “geosynthetic clay liner” and its derivatives as used herein refer to manufactured hydraulic barriers including a bentonite composition and including at least one geosynthetic layer. Apart from geosynthetic clay liner type barriers, other barriers may be created using the disclosed composition with a native soil or blended with powdered or granular bentonite and mixed into a native soil. Such barriers may be used for earthen pits, ditches or ponds when the retention of surface water is critical for either containment of contaminants or for agricultural use (for example, crops, livestock, etc.). In embodiments, clay materials, such as bentonite, have been used as low permeability barriers in containment applications. Without limitations, other clay materials, such as attapulgite, kaolin, hectorite, and combinations thereof, may be used with the disclosed composition.

The bentonite component of the bentonite barrier compositions may include a natural bentonite, a modified bentonite, and combinations thereof. Both granular and powdered bentonite may be suitable; however, granular bentonite rather than powdered bentonite may be suitable in some embodiments for ease of manufacturing reasons. In one or more embodiments, modified bentonites may be suitable. These may include those modified with potassium (K), sodium (Na), calcium (Ca), and aluminum (Al). In one or more embodiments, the modified bentonites may be acid-activated, organically modified, and combinations thereof. Sodium bentonite may be suitable in the bentonite barrier compositions of the present invention. Sodium bentonite's enhanced ability to swell may be useful in the applications discussed herein.

In some embodiments, the bentonite that is used in the bentonite barrier compositions of the present invention may be pre-hydrated, if desired. For instance, the bentonite may have about a 50% moisture content for some applications. This may be an option when manufacturing a geosynthetic clay liner.

As to the granular embodiments, the size of the particles may vary and can affect the packing of the bentonite and its ease of use. Suitable granular bentonites may have a d₉₀ (which is herein referred to as the equivalent diameter where 90 mass-% (of the particles) of the powder has a smaller diameter (and hence the remaining 10% is coarser)) for the bentonite of about 6 mesh to about 60 mesh.

For the powdered bentonites, any suitable powdered bentonite useful for applications discussed herein is suitable for use in the present invention. Examples may have a d₅₀ of about 10 mesh to about 400 mesh. d₅₀ is the average equivalent diameter where 50 mass-% (of the particles) of the powder have a larger equivalent diameter, and the other 50 mass-% have a smaller equivalent diameter. In some embodiments, the d₅₀ may be about 200 mesh.

An example of a suitable powdered bentonite for use in the present invention may include the following particle size distribution: 100% has to pass through a 100 mesh, a minimum of 67% pass through a 200 mesh, and 2% pass through a 325 mesh.

Presently, bentonites for geosynthetic clay liner usage may be specified based on performance in deionized water, yet it is widely recognized that many real-world leachates hinder the ability of bentonite to form an impermeable seal due to high ionic conductivity and/or dissolved multivalent inorganic species. To address such a problem, solid water-soluble organic polymers are sometime blended with bentonite to enhance performance in challenging leachates such as those generated from coal combustion residuals or municipal solid waste.

In one or more example, the polyanionic polymer of the bentonite barrier compositions of the present invention may be carboxymethyl starch. Such organic starch may dissociate into anions in solution. Without limitations the polyanionic starch may be sourced from potato, tapioca, wheat, corn, waxy maize, and combinations thereof. In embodiments, the starch source may be chosen based upon desired performance properties. Without limitations, performance properties may be altered based on molecular weight, degree of substitution, degree of crosslinking, and combinations thereof. In one or more embodiments, crosslinking may be performed using glyoxal, epichlorohydrin, and combinations thereof. Molecular weight may impact viscosity and therefore increase viscous drag of the leachate. The degree of substitution may change water solubility and polymer chain conformation. Crosslinking may prevent the polymer from eluting from the polymer-bentonite mixture or otherwise change conformation. While carboxymethyl starch may improve performance with coal combustion residual and municipal solid waste leachates, carboxymethyl starch may be used for applications in brackish or saltwater conditions (for example, subgrade waterproofing). Carboxymethyl starch may be more resistant to biodegradation, more water-soluble, and more leachate tolerant than unmodified starch. Without limitations, other derivatives of starch may be used, such as hyrdroxyethyl starch, hydroxypropyl starch, cationic starch, and combinations thereof. Blends of substituted starch and other polymers such as, but not limited to, carboxymethyl cellulose, polyanionic cellulose, hydroxyethyl cellulose (HEC), xanthan gum, guar gum, welan gum, locust bean gum, alginate, carrageenan, diutan, scleroglucan, and combinations thereof, may be used in substitution of the carboxymethyl starch. Starch polymer derivatives of carboxymethyl starch may hydrate in a more efficient manner than non-derivatized starches. These derivatives may help the starch polymers resist biodegradation from microbes that non-derivatized starches are well known to suffer from. In one or more embodiments, the derivatives may improve the function and effective usage time compared to conventional starch additives.

In some embodiments, the molecular weight of the carboxymethyl starch may be about 2,000,000 or less. In some embodiments, the molecular weight of the carboxymethyl starch may be about 1,000,000 to about 2,000,000. In some embodiments, the molecular weight of the carboxymethyl starch may be about 1,000,000 or less. It should be noted that if the polymers have too high of a molecular weight, this could lead to a flocculation in the clays, which is undesirable.

The particle size of the carboxymethyl starch may be specified to facilitate blending with bentonite of a known particle size, such as U.S. 200-mesh (75 μm), U.S. 30-mesh (595 μm), or U.S. 16-mesh (1.19 mm). Blending of the carboxymethyl starch with bentonite may occur in a concentration range from about 0.1% to about 10% by weight of bentonite. In some embodiments, the concentration of the carboxymethyl starch in the bentonite barrier compositions of the present invention may be about 2% to about 5%. In some embodiments, the concentration of the carboxymethyl starch in the bentonite barrier compositions of the present invention may be about 5% to about 10%. To determine the optimal amount to include, one should consider the composition (for example, ionic content) and the concentration of any leachates present in the containment.

In one or more embodiments, powdered and/or granular additives can be included into the blends of bentonite and carboxymethyl starch that may provide enhanced containment of environmentally hazardous components (for example, hydrocarbon waste). Without limitations such additives may be organophilic clay, diatomaceous earth, synthetic and natural zeolites, activated carbon, cation exchange resins, sodium carbonate, sodium bicarbonate, ethylenediaminetetraacetic acid (EDTA), other organic or inorganic chelating agents, and combinations thereof.

Although not wanting to be limited by any theory, it is believed that the carboxymethyl starch may effectively binds (or chelate) the electrolytes that are present in the containment, which prevents their interaction with the bentonite in the composition. Additionally, the carboxymethyl starch may provide some viscosity to the solution. The carboxymethyl starch may also have a good molecular weight for interaction with the montmorillonite in the bentonite.

In some embodiments, the bentonite barrier compositions of the present invention, may further include at least one additive. Suitable additives include sodium carbonate, magnesium oxide, magnesium hydroxide, and combinations thereof. If present, in some embodiments, these may be included in an amount of about 1% to about 8%, based on the dry weight of the composition. In some embodiments, they may be included in an amount of about 3% to about 4% based on the dry weight of the composition. In some embodiments, they may be included in an amount of about 4% to about 8% based on the dry weight of the composition. An indication of the desirability of including these additives is the pH of the leachate in the containment as they may serve as pH adjusters. Additionally, water may be added to the bentonite barrier composition, if desired. Doing so may be desirable to aid manufacturing processes, for example, such as needle punching to form a liner.

The bentonite barrier compositions of the present invention may be used alone, in an amended soil application, or may be used to form a geosynthetic clay liner according to the present invention to form containments of contained matter (such as fluids and solids) to provide separation or to form a barrier between contained matter from the surrounding environment.

The contained matter may be aqueous and/or contain solids. In some embodiments, the contained matter may contain leachates. If desired, for example, to meet regulation standards, the bentonite barrier compositions of the present invention may be used to form aqueous containment ponds. The surrounding environment may contain groundwater. Oftentimes in containment applications, it is desirable to maintain as much separation as possible between the contained matter and the groundwater in the surrounding environment to minimize the potential contamination of the ground water by the contained matter (for example, leachates) in the containment.

In some embodiments, the bentonite barrier compositions of the present invention may also be used alone (i.e., without combining it with soil or a geosynthetic layer) to form containments.

In amended soil applications, for example, one could mix the bentonite barrier compositions of the present invention with soil to impart a particular permeability to the soil, for example, in decorative ponds, fish ponds, and irrigation ponds. Such processes may be referred to as “amended soil” applications. The ratio of bentonite to soil may vary in any given amended soil application. In some embodiments, the ratio of bentonite to soil may be 50/50. In others, the ratio may be 60/40. In others, the ratio may be 30/70. In others, the ratio may be 25/75. In others, the ratio may be 1/99. The composition is then compacted using known compaction processes to form the desired containment.

In some embodiments, the bentonite barrier compositions of the present invention may be used to form geosynthetic clay liners. In some embodiments, the geosynthetic clay liners of the present invention may be especially suitable for containment applications to separate contained matter that includes complex electrolyte chemistries from the surrounding environment. Blends of bentonite and carboxymethyl starch may be sandwiched between two plastic sheets for production of geosynthetic clay liners or adhered to a single plastic sheet for production of waterproofing liners. Geosynthetic clay liners or waterproofing liners may conceivably offer improved performance in containment of leachates such as: coal combustion residuals, municipal solid waste, low-level radioactive waste, mining/heap leach tailings, saline/brackish water, seawater, produced/flowback water, and combinations thereof. Hydrocarbon contaminants might also be contained by embodiments including, but not limited to, hydrophobically-modified starches.

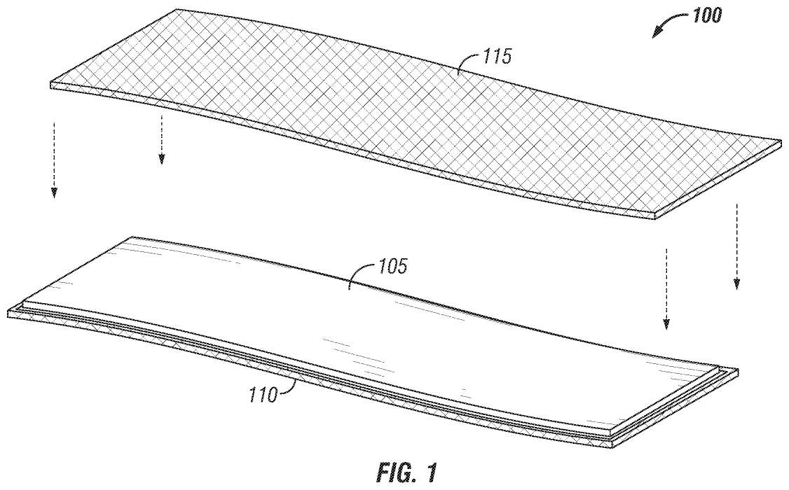

The geosynthetic clay liners of the present invention may include at least one geosynthetic layer and a bentonite barrier composition of the present invention. Turning now to the figures, FIG. 1 illustrates a geosynthetic clay liner 100. The geosynthetic layers of the present invention may include, but are not limited to, geotextiles, geofilms, geomembranes, and combinations thereof. Examples of geosynthetic layers suitable for use in some embodiments may have extremely good puncture resistance. To form the geosynthetic clay liner 100, a bentonite composition 105 of the present invention may be disposed upon a first geosynthetic layer 110, for example, in a uniform distribution across the first geosynthetic layer 110. Oftentimes, the bentonite composition 105 may be adhered to the first geosynthetic layer 110, for example, by an adhesive and/or by mechanical means. Suitable mechanical means may include needle punching, compression techniques, stitch bonding, and combinations thereof. In one or more embodiments, a second geosynthetic layer 115 may be disposed onto the bentonite composition 105 such that the bentonite composition is disposed between the first geosynthetic layer 110 and the second geosynthetic layer 115. In embodiments, the geosynthetic layers 110, 115 may have a thickness of about 0.5 mm to about 2 mm. In some embodiments, the thickness may be less than about 0.5 mm. In some embodiments, the thickness may be from about 0.5 mm to about 1 mm.

Geotextiles that are suitable for use in the present invention are permeable fabrics that have the ability to separate, filter, reinforce, protect, and/or drain. The geotextiles may hold the bentonite in the desired configuration. The geotextiles may be suitable to form sandwich geosynthetic clay liners (for example, geosynthetic clay liner 100) described herein or to form single layer geosynthetic clay liners as described herein (for example, wherein the bentonite composition is coupled to either the first geosynthetic layer 110 or the second geosynthetic layer 115).

Suitable geotextiles may include polypropylene, polyester, or blends thereof, and can be woven or nonwoven. Needle-punched and heat-bonded types of geotextiles are examples of nonwoven geotextiles. More specific examples of suitable geotextiles may include, but are not limited to, polypropylene (“PP”) nonwoven or woven geotextiles, polyethylene terephthalate (“PET”) woven or nonwoven geotextiles, or woven or nonwoven geotextiles that include a blend of PP or PET.

In some embodiments of the present invention, the geotextiles may be coated with a coating or laminated with a geofilm. Suitable coatings may include, but are not limited to, PP coatings and polyurethane coatings. Also, in some embodiments of the present invention, a geofilm (described below) may be laminated to a geotextile through a suitable lamination process. Examples of suitable lamination techniques include heat processes and adhesive bonding. Using coatings or laminations may improve the durability of the geosynthetic clay liner.

Suitable geofilms for use in the present invention may be durable films that are capable of being used in a containment application. An example of a geofilm may be an impermeable film having a thickness of at least about 1 mm to about 10 mm. In embodiments, the thickness may be from about 1 mm to about 5 mm. In embodiments, the thickness may be from about 5 mm to about 10 mm. Suitable geofilms may include high density polyethylene (“HDPE”), low density polyethylene (“LDPE”), linear low density polyethylene (“LLDPE”), PP, polyvinylchloride (“PVC”), thermoplastic olefinic elastomers (“TPO”), ethylene propylene diene monomer (“EPDM”), and combinations thereof.

Suitable geomembranes for use in the present invention are a kind of geosynthetic film that is a thicker film (for example, 10 mm or thicker). Geomembranes may be made of various materials. including, but not limited to, HDPE, LDPE, LLDPE, PP, PVC, TPO, EPDM, and combinations thereof. In some embodiments, these geomembranes may be reinforced with a geotextile.

In some embodiments, a bentonite barrier composition (for example, bentonite composition 105) of the present invention may be adhesively bonded to a geomembrane to form a geosynthetic clay liner (for example, geosynthetic clay liner 100). In some embodiments, the bentonite barrier composition and the adhesive may be applied in alternating layers up to a desired thickness or weight of bentonite per square foot of the geosynthetic clay liner. When an adhesive is used, the adhesive may be used in an amount of about 0.001 g/ft² to about 0.1 g/ft². In some embodiments, the adhesive may be used in an amount of about 0.001 g/ft² to about 0.05 g/ft². In some embodiments, the adhesive may be used in an amount of about 0.05 g/ft² to about 0.1 g/ft². Examples of adhesives suitable for use include, but are not limited to, those including an acrylic polymer, polyvinyl acetate, waterborne polyurethane dispersions, and combinations thereof.

In the sandwich geosynthetic clay liner embodiments of the present invention, a bentonite barrier composition of the present invention may be sandwiched between at least two geosynthetic layers to form a sandwich geosynthetic clay liner that may be especially suitable for use in aqueous containment applications including complex chemistries. In some such sandwich geosynthetic clay liner embodiments, geotextiles may be suitable for use in some embodiments as at least one of the geosynthetic layers. In other sandwich geosynthetic clay liner embodiments, a mix of geosynthetic layers may be used, (for example, a geotextile as the first geosynthetic layer 110 and a geomembrane as the second geosynthetic layer 115, or vice-versa). In other embodiments, geofilms and geomembranes may also be incorporated in sandwich geosynthetic clay liners of the present invention. In certain embodiments, a geofilm or a geomembrane may be laminated on a geotextile to form a geosynthetic layer for the geosynthetic clay liner.

In the sandwich geosynthetic clay liner embodiments of the present invention, the sandwich layer between the geosynthetic layers includes a bentonite barrier composition of the present invention. For example, the amount of bentonite barrier compositions in the sandwich layer of the liner may be about 0.25 lb/ft² to about 3 lb/ft² of the clay liner. In some embodiments, the amount of bentonite barrier compositions in the sandwich layer of the liner may be about 0.50 lb/ft² to about 1 lb/ft² of the clay liner. In some embodiments, the amount of bentonite barrier compositions in the sandwich layer of the liner may be about 0.75 lb/ft² to about 2 lb/ft² of the clay liner. The thickness of the sandwich layer may also vary. In some embodiments, the thickness of the sandwich layer may be about 0.01 inch to about 2 inches in thickness. In some embodiments, the thickness of the sandwich layer may be about 0.01 inch to about 1 inch in thickness. In some embodiments, the thickness of the sandwich layer may be about 1 inch to about 2 inches in thickness.

In some embodiments, moisture may be added to the bentonite composition so that when the sandwich layers are compressed (for example, by suitable rollers), the bentonite in effect sticks to the geosynthetic layers to maintain the sandwich geosynthetic clay liner.

In other embodiments, a sandwich geosynthetic clay liner may be formed using a needle-punch or stitch-bonding technique.

The geosynthetic clay liners of the present invention may exhibit enhanced retained permeabilities that can be maintained over longer periods of time (for example, in some embodiments, 30 days or more; in some embodiments, 365 days or more). Additionally, at least in some embodiments, it is believed that the geosynthetic clay liners of the present invention may retain these permeabilities for the useful life of the liner, depending on the application.

Additionally, in embodiments, the geosynthetic clay liners of the present invention may have a retained permeability that is better than 1×10⁻⁸ cm/s. In some embodiments, the permeability of the geosynthetic clay liners of the present invention may have a retained permeability that is better than 1×10⁻⁹ cm/s, which represents one order of magnitude increase in retained permeability. In some embodiments, it is believed that the retained permeability of the geosynthetic clay liners of the present invention may be about 1×10⁻¹⁰ cm/s.

Without limitations, the bentonite barrier compositions of the present invention exhibit enhanced permeability properties in complex electrolyte environments (for example, in fly ash, coal ash leachate environments, etc.) because of high electrolyte resistance. In conventional bentonite compositions, the presence of electrolytes may significantly decrease the stability of the hydration of the bentonite, which can disrupt the clay mineral structure of the bentonite. The electrochemical forces of polyanionic low molecular weight polymer may affect chelating the electrolytes in solution, thus, preserving the ability of the bentonite to swell in the composition.

To facilitate a better understanding of the present invention, the following examples of certain embodiments are given. In no way should the following examples be read to limit, or to define, the scope of the invention.

In order to demonstrate the effectiveness of geosynthetic clay liners of the present invention and the bentonite barrier compositions of the present invention, the following representative examples are given. They involve testing the geosynthetic clay liners of the present invention and the bentonite barrier compositions of the present invention in exemplary solutions including complex electrolyte chemistries.

### Example 1

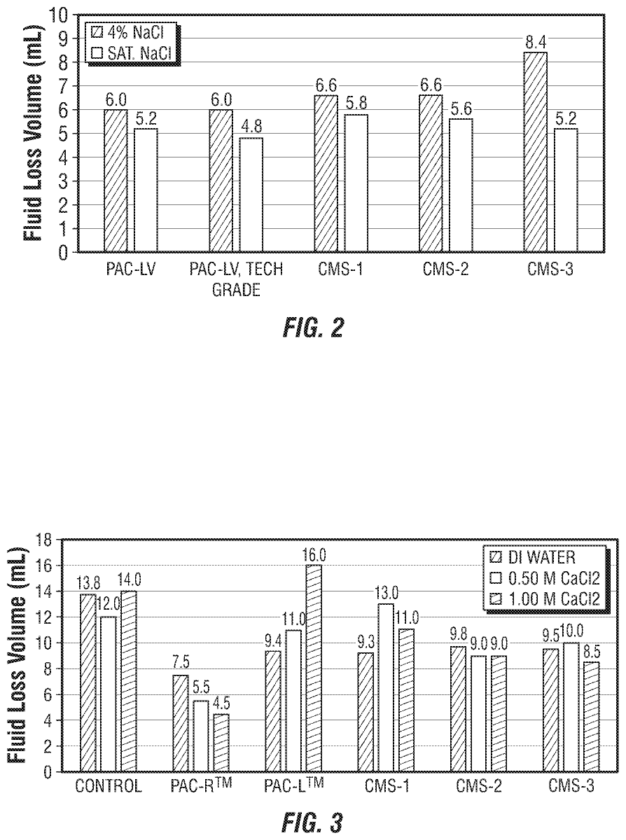

With reference now to FIG. 2, various carboxymethyl starch (CMS) products are illustrated in comparison to conventional polyanionic cellulose (PAC) products. In testing, the present data illustrates carboxymethyl starch products were compared to low-viscosity polyanionic cellulose in fluid loss tests prescribed by API 13A, Clause 16. At first, 22.5 g of bentonite was mixed with 350 mL of either 4% NaCl or saturated NaCl. The resulting solutions were then added 3.5 g of either PAC or CMS (10% additive by weight of bentonite). The polymer (for example, the CMS or PAC) and the bentonite were incorporated together in a dry blend at 2% and added at the same time, so tests were done with either 22.5 g of pure bentonite or 22.05 g of bentonite and 0.45 g of polymer blended together. After aging for about 16 hours, the fluids were tested for fluid loss at room temperature under 100 psi of pressure, yielding the data shown in FIG. 2. As demonstrated by the results, saltwater performance of bentonite was blended with either CMS or low-viscosity PAC was similar. The saltwater performance of the bentonite blended with the CMS was better than the performance of a control amount of bentonite alone. These data support the capability of bentonite/CMS blends to perform under saltwater conditions encountered by geosynthetic clay liners and waterproofing membranes.

### Example 2

With reference now to FIG. 3, high- and low-viscosity PACs were compared to CMS additives, provided by AquaSol, through a series of fluid loss experiments in deionized (DI) water and CaCl2 solutions. In the experiments, 22.50 g of dry material including either bentonite or bentonite blended with 2 wt % polymer additive were mixed with 350 mL of deionized water. The resulting mixtures were then tested for 30-minute API fluid loss at room temperature and 100 psi of pressure—these results were reported as “DI water” in FIG. 3. After 30 minutes, the fluid was emptied from the fluid loss cell but the filter cake and filter paper were retained. In volume, 100 mL of either 0.50 M CaCl2 or 1.00 M CaCl2 were then added to the cell and pressure was reapplied. Fluid loss was reported again after an additional 30 minutes as either “0.50 M CaCl2” or “1.00 M CaCl2” in FIG. 3. This procedure simulates pre-hydration of bentonite in a geosynthetic clay liner occurring from soil pore water, followed by contact with high conductivity, high hardness leachate. The results demonstrate that the CMS additives reduced bentonite fluid loss volume as compared to a control sample not containing any polymer additives. Performance for CMS additives generally ranked between low-viscosity and high-viscosity PAC.

An embodiment of the present disclosure is a geosynthetic clay liner, including at least one geosynthetic layer; and a bentonite barrier composition including bentonite and a polyanionic starch.

In one or more embodiments described in the preceding paragraph, wherein the polyanionic starch is carboxymethyl starch. In one or more embodiments described above, wherein the polyanionic starch has a degree of substitution from carboxymethyl starch, wherein blends of substituted starch and other polymers are selected from a group consisting of carboxymethyl cellulose, polyanionic cellulose, hydroxyethyl cellulose (HEC), xanthan gum, guar gum, welan gum, locust bean gum, alginate, carrageenan, diutan, scleroglucan, and combinations thereof, for use in the substitution of carboxymethyl starch. In one or more embodiments described above, wherein the polyanionic starch is sourced from potato, tapioca, wheat, corn, waxy maize, and combinations thereof. In one or more embodiments described above, the geosynthetic clay liner further including a derivative of the polyanionic starch, wherein the derivative is selected from a group consisting of hyrdroxyethyl starch, hydroxypropyl starch, cationic starch, and combinations thereof. In one or more embodiments described above, wherein the polyanionic starch is blended with the bentonite in a concentration range from about 0.1% to about 10% by weight of bentonite. In one or more embodiments described above, wherein the geosynthetic layer is a geotextile or a geomembrane. In one or more embodiments described above, wherein the bentonite barrier composition further includes an additive, wherein the additive is selected from a group consisting of organophilic clay, diatomaceous earth, synthetic and natural zeolites, activated carbon, cation exchange resins, sodium carbonate, sodium bicarbonate, ethylenediaminetetraacetic acid (EDTA), other organic or inorganic chelating agents, and combinations thereof. In one or more embodiments described above, wherein the geosynthetic layer includes a structure selected from the group consisting of a nonwoven structure, a woven structure, and any combination thereof. In one or more embodiments described above, wherein the bentonite barrier composition is present in an amount of about 0.25 to about 3 lb/ft² of the geosynthetic clay liner.

Another embodiment of the present disclosure is a method, including providing a geosynthetic clay liner including a first geosynthetic layer; a second geosynthetic layer; and a bentonite barrier composition that is disposed between the first geosynthetic layer and the second geosynthetic layer, wherein the bentonite barrier composition includes bentonite and a polyanionic starch; and forming a containment using the geosynthetic clay liner to provide at least partial separation for a containment from its environment.

In one or more embodiments described in the preceding paragraph, wherein the polyanionic starch is carboxymethyl starch. In one or more embodiments described above, wherein the polyanionic starch has a degree of substitution from carboxymethyl starch, wherein blends of substituted starch and other polymers are selected from a group consisting of carboxymethyl cellulose, polyanionic cellulose, hydroxyethyl cellulose (HEC), xanthan gum, guar gum, welan gum, locust bean gum, alginate, carrageenan, diutan, scleroglucan, and combinations thereof, for use in the substitution of carboxymethyl starch. In one or more embodiments described above, wherein the polyanionic starch is sourced from potato, tapioca, wheat, corn, waxy maize, and combinations thereof. In one or more embodiments described above, the geosynthetic clay liner further including a derivative of the polyanionic starch, wherein the derivative is selected from a group consisting of hyrdroxyethyl starch, hydroxypropyl starch, cationic starch, and combinations thereof. In one or more embodiments described above, wherein the polyanionic starch is blended with the bentonite in a concentration range from about 0.1% to about 10% by weight of bentonite. In one or more embodiments described above, wherein both the first geosynthetic layer and the second geosynthetic layer are a geotextile or a geomembrane. In one or more embodiments described above, wherein the bentonite barrier composition further includes an additive, wherein the additive is selected from a group consisting of organophilic clay, diatomaceous earth, synthetic and natural zeolites, activated carbon, cation exchange resins, sodium carbonate, sodium bicarbonate, ethylenediaminetetraacetic acid (EDTA), other organic or inorganic chelating agents, and combinations thereof. In one or more embodiments described above, wherein both the first geosynthetic layer and the second geosynthetic layer include a structure selected from the group consisting of a nonwoven structure, a woven structure, and any combination thereof. In one or more embodiments described above, wherein the bentonite barrier composition is present in an amount of about 0.25 to about 3 lb/ft² of the geosynthetic clay liner

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A geosynthetic clay liner comprising:
at least one geosynthetic layer; and
a bentonite barrier composition comprising:
bentonite and a polyanionic starch.

2. The geosynthetic clay liner of claim 1, wherein the polyanionic starch is carboxymethyl starch.

3. The geosynthetic clay liner of claim 2, wherein the polyanionic starch has a degree of substitution from carboxymethyl starch, wherein blends of substituted starch and other polymers are selected from a group consisting of carboxymethyl cellulose, polyanionic cellulose, hydroxyethyl cellulose (HEC), xanthan gum, guar gum, welan gum, locust bean gum, alginate, carrageenan, diutan, scleroglucan, and combinations thereof, for use in the substitution of carboxymethyl starch.

4. The geosynthetic clay liner of claim 1, wherein the polyanionic starch is sourced from potato, tapioca, wheat, corn, waxy maize, and combinations thereof.

5. The geosynthetic clay liner of claim 1, further comprising a derivative of the polyanionic starch, wherein the derivative is selected from a group consisting of hyrdroxyethyl starch, hydroxypropyl starch, cationic starch, and combinations thereof.

6. The geosynthetic clay liner of claim 1, wherein the polyanionic starch is blended with the bentonite in a concentration range from about 0.1% to about 10% by weight of bentonite.

7. The geosynthetic clay liner of claim 1, wherein the bentonite barrier composition further comprises an additive, wherein the additive is selected from a group consisting of organophilic clay, diatomaceous earth, synthetic and natural zeolites, activated carbon, cation exchange resins, sodium carbonate, sodium bicarbonate, ethylenediaminetetraacetic acid (EDTA), other organic or inorganic chelating agents, and combinations thereof.

8. The geosynthetic clay liner of claim 1, wherein the geosynthetic layer is a geotextile or a geomembrane.

9. The geosynthetic clay liner of claim 1, wherein the geosynthetic layer comprises a structure selected from the group consisting of a nonwoven structure, a woven structure, and any combination thereof.

10. The geosynthetic clay liner of claim 1, wherein the bentonite barrier composition is present in an amount of about 0.25 to about 3 lb/ft² of the geosynthetic clay liner.

11. A method comprising:
providing a geosynthetic clay liner comprising:
a first geosynthetic layer;
a second geosynthetic layer; and
a bentonite barrier composition that is disposed between the first geosynthetic layer and the second geosynthetic layer, wherein the bentonite barrier composition comprises:
bentonite and a polyanionic starch; and
forming a containment using the geosynthetic clay liner to provide at least partial separation for a containment from its environment.

12. The method of claim 11, wherein the polyanionic starch is carboxymethyl starch.

13. The method of claim 12, wherein the polyanionic starch has a degree of substitution from carboxymethyl starch, wherein blends of substituted starch and other polymers are selected from a group consisting of carboxymethyl cellulose, polyanionic cellulose, hydroxyethyl cellulose (HEC), xanthan gum, guar gum, welan gum, locust bean gum, alginate, carrageenan, diutan, scleroglucan, and combinations thereof, for use in the substitution of carboxymethyl starch.

14. The method of claim 11, wherein the polyanionic starch is sourced from potato, tapioca, wheat, corn, waxy maize, and combinations thereof.

15. The method of claim 11, wherein the geosynthetic clay liner further comprises a derivative of the polyanionic starch, wherein the derivative is selected from a group consisting of hyrdroxyethyl starch, hydroxypropyl starch, cationic starch, and combinations thereof.

16. The method of claim 11, wherein the polyanionic starch is blended with the bentonite in a concentration range from about 0.1% to about 10% by weight of bentonite.

17. The method of claim 11, wherein the bentonite barrier composition further comprises an additive, wherein the additive is selected from a group consisting of organophilic clay, diatomaceous earth, synthetic and natural zeolites, activated carbon, cation exchange resins, sodium carbonate, sodium bicarbonate, ethylenediaminetetraacetic acid (EDTA), other organic or inorganic chelating agents, and combinations thereof.

18. The method of claim 11, wherein both the first geosynthetic layer and the second geosynthetic layer are a geotextile or a geomembrane.

19. The method of claim 11, wherein both the first geosynthetic layer and the second geosynthetic layer comprise a structure selected from the group consisting of a nonwoven structure, a woven structure, and any combination thereof.

20. The method of claim 11, wherein the bentonite barrier composition is present in an amount of about 0.25 to about 3 lb/ft² of the geosynthetic clay liner.
